(19) United States
(12) Patent Application Publication
(10) Pub. No.: US 2026/0077218 A1
(43) Pub. Date: Mar. 19, 2026

(54) Wearable air purifier

(71) Applicant: MAHADEVAN SUBRAMANI, PORT ST LUCIE, FL (US)

(72) Inventor: MAHADEVAN SUBRAMANI, PORT ST LUCIE, FL (US)

(21) Appl. No.: 18/196,820

(22) Filed: May 12, 2023

(51) Int. Cl. A62B 18/00; A62B 7/10; A62B 18/04

(52) U.S. Cl. CPC A62B 18/003; A62B 7/10; A62B 18/045

(57) ABSTRACT

The Wearable air purifier sought to be patented here is a new type of PPE among products such as Facial masks and Facial hoods. It achieves the objective of breathing in pure air in the least physically invasive manner while Facial masks and Facial hoods are extremely physically invasive. The discomfort of a fabric pressing against parts of human face and the difficulty imposed on the breathing process is avoided by wearing a Wearable air purifier. Along with the movable transparent visor, the Wearable air purifier is a clean air supply device in a design and form profile that all are familiar with, the baseball cap.

### CROSS REFERENCE TO RELATED APLLICATIONS

Provisional Patent application number: 63/343,589

### STSTEMENT REGARDING FEDERALLY SPONSERED RESEARCH OR DEVELOPMENT

Not applicable.

### REFERENCE TO SEQUENCR LISTING, A LARGE TABLE OR A COMPUTER PROGRAMLISTING APPENDIX ON READ ONLY OPTICAL DISC

Not applicable

### BACKGROUND OF THE INVENTION

The Wearable air purifier is a Personal Protective Equipment aka PPE. In the wake of the COVID Pandemic in recent past, there was widespread use of Facial Masks, Facial shields, and Facial Hoods. The Wearable air purifier was conceived and developed in this background. The discomfort resulting from prolonged use of Facial Masks and Facial Hoods motivated the creation of the Wearable Air Purifier.

### BRIEF SUMMARY OF THE INVENTION

The Wearable Air Purifier is a device to supply filtered air for breathing. The surrounding air is drawn through an N95 or higher filtration material and channeled by a battery operated micro fan blower to stream down the face as a facial air curtain. The air curtain acts as a barrier against unfiltered surrounding air and surrounds the nostrils and mouth with filtered air for breathing. The Wearable air purifier combines a transparent and position adjustable Face shield as an integral part, to block turbulent surrounding air from compromising the strength of the Facial air curtain.

The Wearable air purifier overcomes the discomfort experienced while wearing Facial Masks and Hoods. Facial masks are very uncomfortable especially when worn for hours. They constrict natural breathing function. They cause sweating and stickiness in face. It is difficult to carry on a conversation. Adverse health effects, both physical and psychological, resulting from wearing a Facial Mask and Facial Hood are avoided by using the Wearable air purifier. Difficulty in readily recognizing faces covered by Facial masks and Facial Hoods is also eliminated by wearing the Wearable air purifier. The human need to be presentable is well served by the Wearable air purifier along with the main objective of keeping contaminated air at bay.

### BRIEF DESCRIPTION OF THE SEVERAL VIEWS OF THE DRAWING

FIG. 1 Is a fully assembled view of the Wearable air purifier. This is the preferred

embodiment of the invention.

FIG. 2 is also assembled product views as seen from various sides, A the top outside view, B the right hand sideview, C the front outside view, D the left hand sideview

and E the top outside view of the fully assembled Wearable air purifier.

FIG. 3 is an exploded view of the Wearable air purifier.

FIG. 3 A is the protective cover for the filter material. The cover also enables placing

the air vent inlet openings.

FIG. 3 B is the filter material of N95 or higher efficiency such as HEPA and ULPA.

FIG. 3 C is the air purifier unit housing. The housing contains the blower fan/motor.

FIG. 3 D is the ON/OFF switch to start/stop the air purification unit.

FIG. 3 E is the battery housing and the battery.

FIG. 3 F is the blower fan/motor.

FIG. 3 G is the bottom cover of the air purification unit.

FIG. 3 H is a cap similar to baseball cap, modified to fit all parts into one product.

FIG. 3 I is the transparent facial shield. The shield can be moved to either horizontal

or vertical positions.

FIG. 4 is the air purification unit views.

FIG. 4 A shows top outside view, FIG. 4 B shows right hand side view, FIG. 4 C shows

front outside view, FIG. 4 D shows left hand side view, and FIG. 4 E shows bottom
inside view of the air purification unit.
The air purification unit casing is made of suitable plastic material.

FIG. 5 depicts the bottom cover of air purification unit.

FIG. 5 A is the bottom inside view, FIG 5 B is the right hand side view, FIG 5 C shows

front side view and FIG. 5 D is the top outside view of the bottom cover of the air filtration unit.

FIG. 6 depicts the filter protection cover on the very top of the Wearable air purifier.

FIG. 6 A shows bottom inside view, 6 B and FIG. 6 C are side views of the dome like

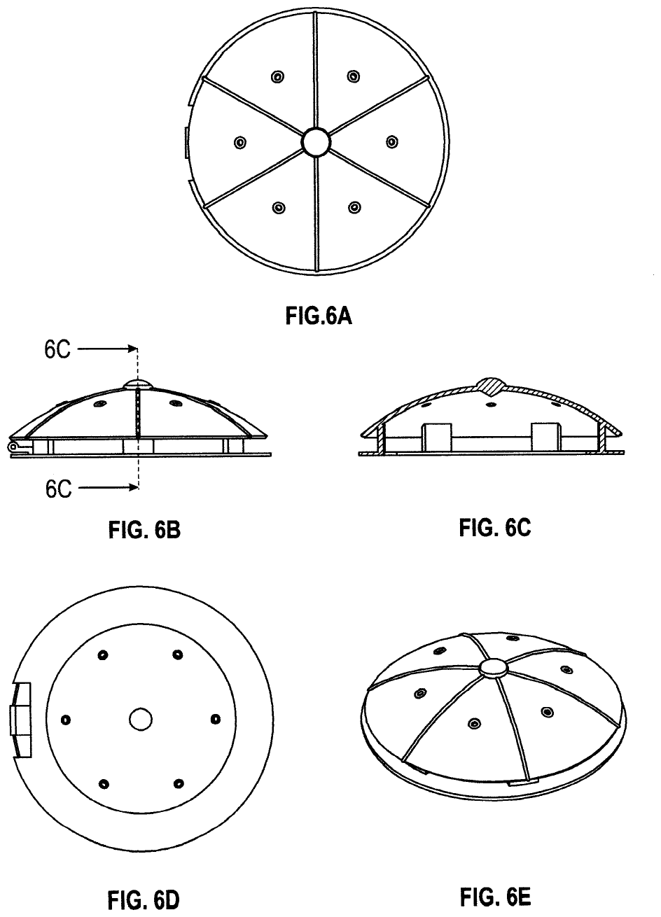

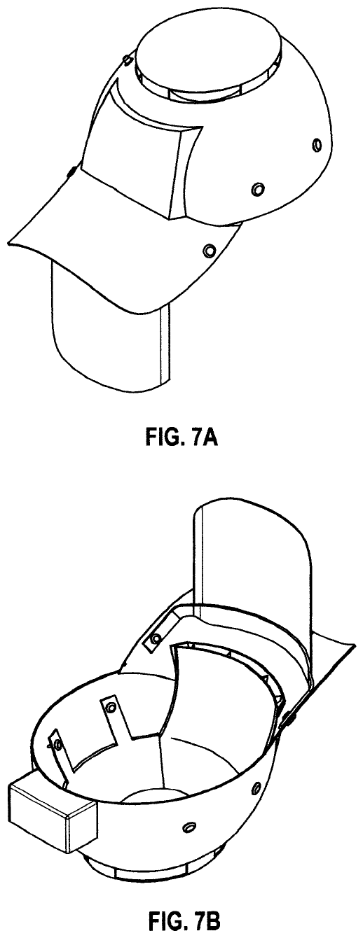

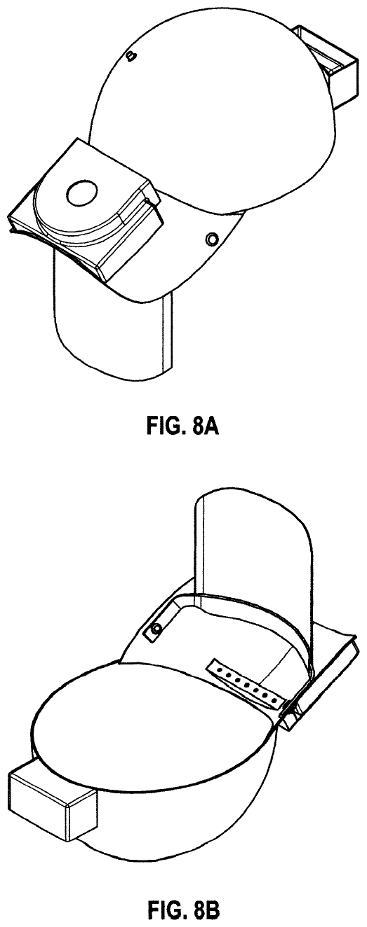

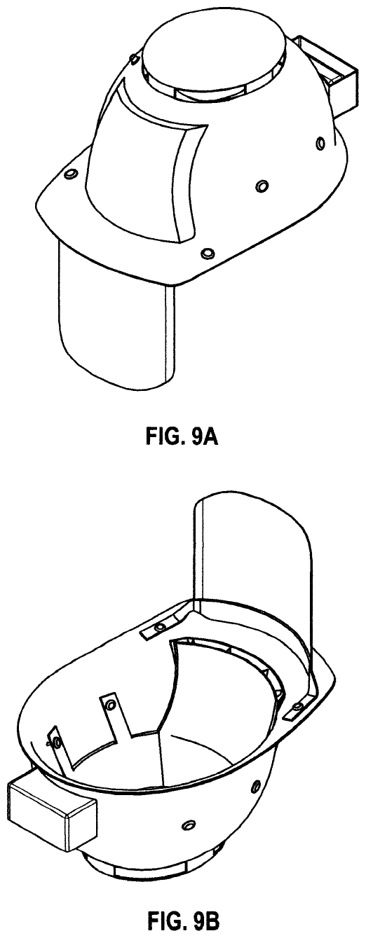

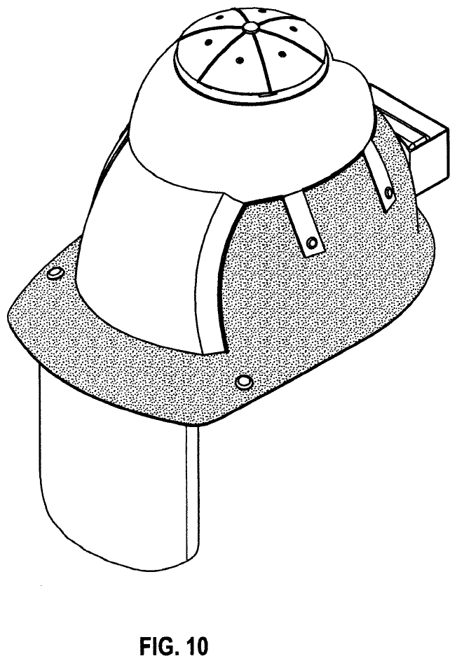

filter cover. FIG. 6 D and FIG 6 E are depicting the top outside view of the filter cover.

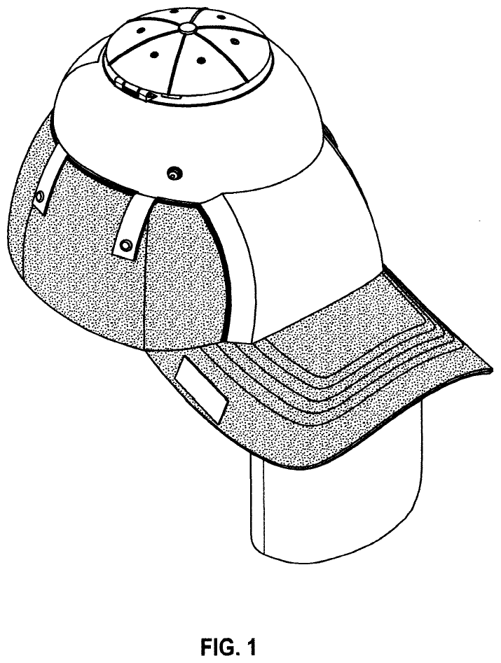

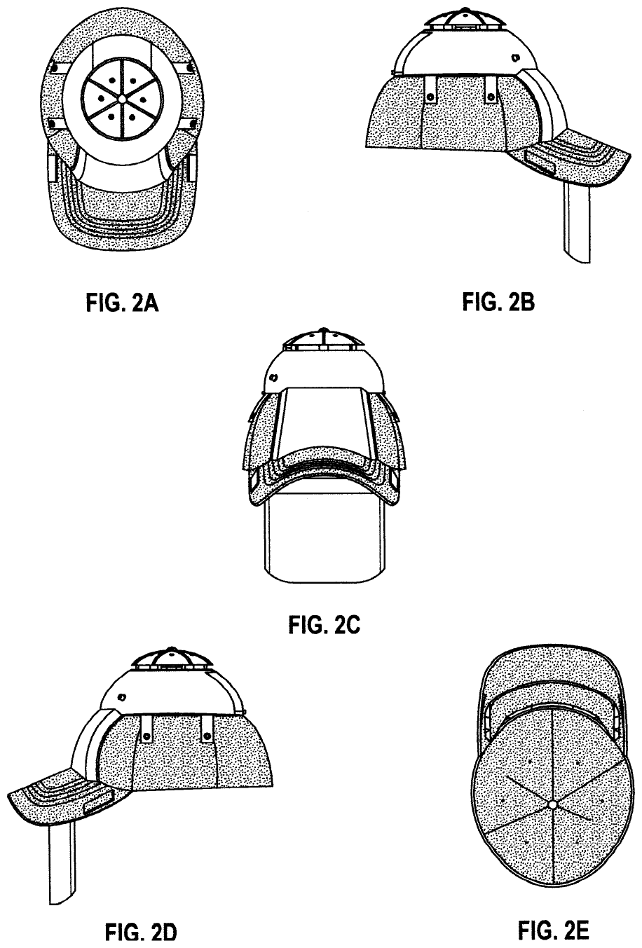

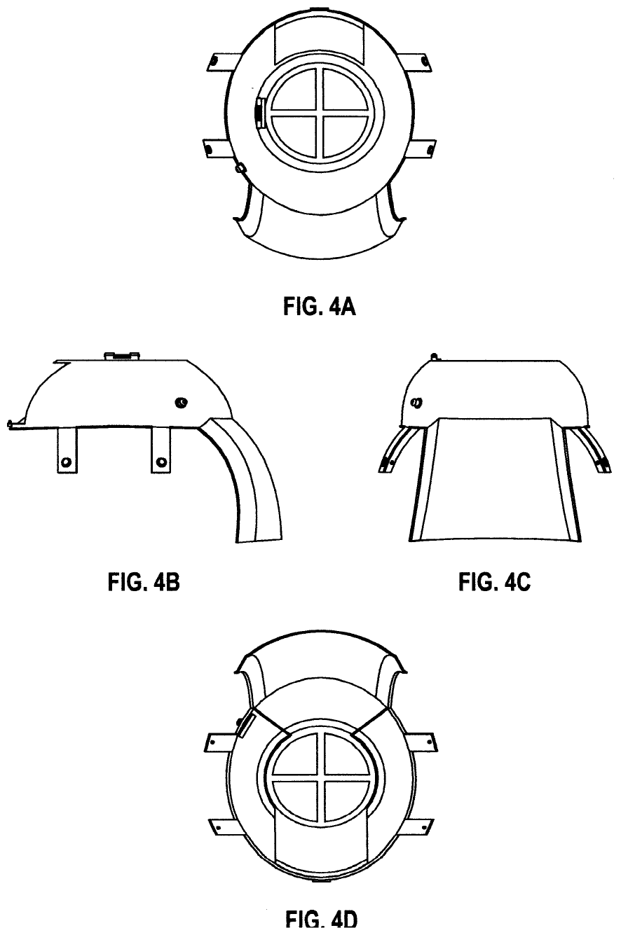

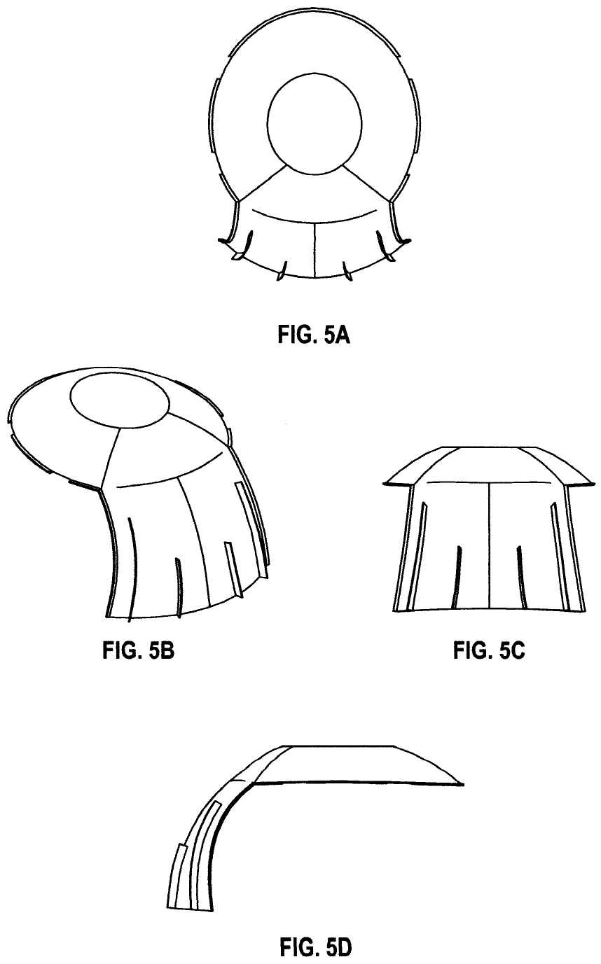

FIG. 1 through FIG. 6 briefly described so far is the preferred embodiment of the

Wearable air purifier. FIG. 7 through FIG. 10 are depictions of other variants of the

Wearable air purifier.

FIG. 7 is an assembled product of the Wearable air purifier variant with the air purification unit concealed under the cap from outside.

FIG. 7 A is the view from outside and FIG. 7 B is inside bottom view of the assembled Wearable air purifier with concealed air purification unit.

FIG. 8 is another variant or version of the preferred embodiment.

This variant of the
Wearable air purifier achieves the same function, the main differentiating feature

being the placement of purification unit. As FIG. 8 A shows, the outside view of the

assembled product, depicts the air purification unit mounted on top of the cap
visor, unlike the preferred embodiment, where the air purification unit is on top of

the head cover in a baseball cap. FIG. 8 B shows the inside view of assembled

Wearable air purifier variant with visor mounted air purification unit.

FIG. 9 This figure shows assembled unit of the Wearable air purifier in yet another

variant form. In this variant the air purification unit is fitted inside a safety helmet.

FIG. 9 A is showing outside view and FIG. 9 B is showing the inside view of the safety

helmet based version of the Wearable air purifier. FIG. 10 is the helmet based

variant of the Wearable air purifier wherein the air purification unit is fitted on top
of the helmet.

### DETAILED DESCRIPTION OF THE INVENTION

The Wearable air purifier was conceived during the recent covid pandemic to

overcome the discomfort caused by the prolonged use of Facial masks and Facial

hoods. Facial masks and Facial hoods are air filtration fabric worn directly over nose

and mouth. The Wearable air purifier places the filtration fabric away from the nose

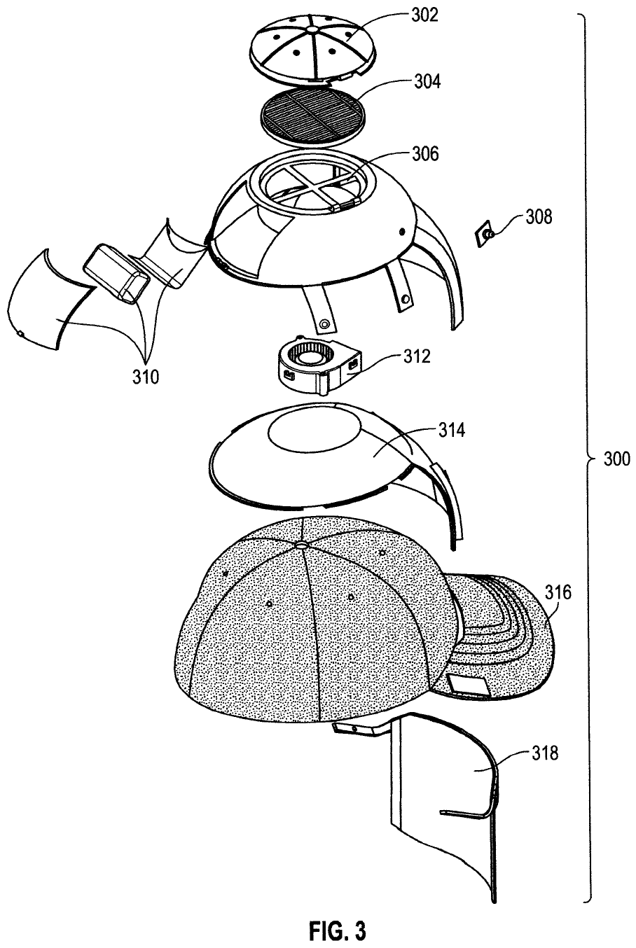

and mouth. In FIG. 3 the filter fabric B is seen on top of the device.

Only the filtered

air is streamed down the face in a manner that filtered air surrounds the nose and

mouth area when the Wearable air purifier is worn and turned on.

The inventor has completed functioning prototype of the preferred embodiment, since applying for a provisional patent in May 2022. The prototype is

made with market available blower fan/motor. Funding to be raised to custom

design and make this critical part. Fund raising is also planned to cover

manufacturing, marketing and launch outlay.

FIG. 8 is a variant of the preferred embodiment in which the distinguishing

feature is the visor mount of the air purification unit. This variant may be
considered an improvement of the market available baseball cap with fan mounted
on visor. The improvement feature is the N95 or higher filter fabric, since market
available baseball cap products with fan do not have this feature.

The functional flow description of the Wearable air purifier starts with the air vents in the top filter cover shown in FIG. 3 A. Air is drawn by the suction power

of blower fan/motor through these air vents, passes through the N95 or higher
filter fabric FIG. 3 B, channeled by the blower fan/motor via an air duct to exit from
air purification unit and streamed down the face. The movable transparent visor
can be positioned vertical to act as a Facial shield or positioned horizontal with the
fabric cap visor.

1. The Wearable air purifier is an article of Personal Protective Equipment aka PPE comprising,
A. An air purification unit that houses a micro blower/fan, filter fabric and battery.
B. Is attached to and forming part of a wearable head gear such as a baseball cap, and
C. Further comprising of an air duct, air vent and movable visor to stream d clean air down the human face.

2. The article of Personal Protective Equipment aka PPE in Claim 1 is rendered in several structural types, broadly grouped under two versions, namely
A. The baseball cap version, this being the preferred embodiment, and
B. The head band version.
The baseball version and the head band version are further rendered into
sub variants. The sub variants are FIG 7 through FIG 10.
The head band version is different in form and design from the preferred embodiment, but delivers the same
functionality towards achieving the objective of breathing in pure air. The head band version is subject of another utility and design patent applications.
